(19) United States
(12) Patent Application Publication
(10) Pub. No.: US 2023/0030929 A1
(43) Pub. Date: Feb. 2, 2023

(54) Instructive Clay Mat Assembly and Method of Use

(71) Applicant: Debora Anne Florek, Agawam, MA (US)

(72) Inventor: Debora Anne Florek, Agawam, MA (US)

(21) Appl. No.: 17/388,040

(22) Filed: Jul. 29, 2021

(51) Int. Cl. G09B 19/00; C04B 33/00

(52) U.S. Cl. CPC G09B 19/00; C04B 33/00

(57) ABSTRACT

An instructive clay mat assembly and method of use provides a lightweight, portable panel built for facilitated carrying and temporary use on a work platform. Further, the wedging mat assembly provides a plurality of clay-related indicia that provides instructions, techniques, and general information and instructions to assist students in molding clay in a classroom environment. The clay-related indicia include at least one of the following indicia: ceramics, wedge, slip, plastic, pinch, slab, coil, score and slip, leather hard, bone dry, fire, kiln, and glaze. The clay-related indicia are strategically disposed near the perimeter of the mat, so as not to be obstructed by the clay. Further, the clay-related indicia are arranged to create a clay molding narrative that helps the student during molding. The instructive nature of the indicia can include: clay types, clay building techniques, and states of during molding clay, and finished states of clay.

### FIELD OF THE INVENTION

The present invention relates generally to an instructive clay mat assembly and method of use. More so, the present invention relates to a lightweight, portable panel built for facilitated carrying and temporary use on a work platform, and comprises clay-related indicia that provides instructions, techniques, and general clay-related information to assist students in molding clay in a classroom environment.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, ceramic materials, such as clay, can include a stiff, sticky fine-grained earth that can be molded when wet, and is dried and fired to make pottery, ceramics, and bricks. There are numerous techniques that must be applied in chronological order to mold clay, as follows:

In general, the clay molding technique of hand-building involves using the hands to form an object out of clay. It encompasses some other, more specific, forming methods as well, like coil building and slab building, and is often used in conjunction with other forming techniques. Ceramic sculpture would fall into the hand-building category since it incorporates many different techniques.

Typically, slab building is a process whereby slabs of clay are rolled or pounded out, either by hand, with a slab roller or rolling pin, and then used to construct objects or vessels. Depending on the aesthetic or design requirements, clay slabs can be used from the wet stage up through leather hard. Many slab builders embellish the slabs with surface designs or textures prior to construction because it is easier to create surfaces when flat rather than after a piece is made.

In the art of molding clay, coiling is the most understood technique for making clay vessels and sculptures. Coils of clay are rolled out, and are built up in a spiral fashion, with the coil being added joined to the coil below it layer after layer until the desired wall height and profile is achieved. This is a great entry-level technique, and will teach you a lot about what clay will and won't do when wet.

Generally, a throwing wheel and the throwing of clay is probably what most people think of when they think of making pottery. A potter will use a manual or electric potter's wheel to center a ball of spinning clay, open it into a vessel, and lift and shape the walls while the wheel is spinning, thereby producing a symmetrical vessel. These vessels can then be textured, decorated, reformed into alternative shapes, or adorned with handles for cups spouts for tea pots or anything your imagination can conjure up.

It is known in the art field that extruding is a technique adapted by clay artists to fit the studio scale. An extruder is a tool with a plunger that forces wet clay through a tube and out through a die at the end of the tube, effectively squeezing the clay into a shape that is determined by the die. Dies can be purchased or made, and the possibilities are many. They are often used to form shapes that are attached to items that have been constructed through other techniques (like handles for mugs).

Typically, slip casting involves using specially designed molds that you pour clay into to form the internal shape of the mold. The clay is poured into the mold and allowed to sit for a while so the mold can wick some of the water from the clay, causing a thin layer of more rigid clay to take the shape of the mold. The excess slip is then poured out of the mold and set aside to dry. When it has sat for enough time, the mold is opened and the hollow clay form is removed. Once removed the seams from the mold are scraped smooth, and the piece is allowed to dry further until it is ready to be bisque fired.

Other proposals have involved mats and boards for molding clay. The problem with these clay mats is that they are not always portable. Also, the student does not always have an instructive narrative to help while molding the clay. Even though the above cited mats and boards for molding clay meet some of the needs of the market, an instructive clay mat assembly that provides a lightweight, portable panel built for facilitated carrying and temporary use on a work platform, and comprises clay-related indicia that provides instructions, techniques, and general clay-related information to assist students in molding clay in a classroom environment, is still desired.

### SUMMARY

Illustrative embodiments of the disclosure are generally directed to an instructive clay mat assembly and method of use. The instructive clay mat assembly provides a lightweight, portable panel built for facilitated carrying and temporary use on a work platform. Further, the wedging mat assembly provides a plurality of clay-related indicia that provides instructions, techniques, and general information and instructions to assist students in molding clay in a classroom environment. The clay-related indicia are strategically disposed near the perimeter of the mat, so as not to be obstructed by the clay. Further, the clay-related indicia are arranged to create a clay molding narrative that helps the student during molding, including: clay types, clay building techniques, and states of during molding clay, and finished states of clay.

In one aspect, an instructive clay mat assembly, comprises:
a flexible panel defining a mount face and a clay face, the mount face being operable to enable mounting on a work platform, the clay face being operable to enable molding a ceramic material, the clay face having a perimeter region and a central region; and
a plurality of clay-related indicia disposed along the perimeter region of the clay face, the clay-related indicia corresponding to at least one of the following: the type of the ceramic material, a technique for molding the ceramic material, a state of the ceramic material while being molded, and a state of the ceramic material after molding,
whereby the clay-related indicia help instruct in molding the ceramic material.

In another aspect, the panel has dimensions of about 12 inches×22 inches.

In another aspect, the panel comprises a washable, vinyl material.

In another aspect, the panel comprises a canvas material.

In another aspect, the panel has a generally square or rectangular shape.

In another aspect, the mount face of the panel is a nonporous material.

In another aspect, the mount face of the panel is a non-slip material.

In another aspect, the mount face mounts on a work platform in an adjacent, parallel relationship.

In another aspect, the clay-related indicia include at least one of the following: a text, a number, and an image.

In another aspect, the plurality of clay-related indicia comprises of thirteen indicia.

In another aspect, the clay-related indicia include at least one of the following indicia: ceramics, wedge, slip, plastic, pinch, slab, coil, score and slip, leather hard, bone dry, fire, kiln, and glaze.

In a second aspect, the ceramic material comprises clay.

In another aspect, the work platform comprises a desk.

In another aspect, the assembly further comprises a carrying case containing a plurality of clay molding tools.

In another aspect, the clay molding tools include at least one of the following: a rolling pin, a sponge, a loop tool, a wire clay cutter, a pro needle, a boxwood tool, a potter's rib, a ribbon tool, and a metal scraper.

In another aspect, the wire clay cutter extends across the mount face.

In another aspect, the carrying case is portable.

One objective of the present invention is to provide a portable wedging mat.

Another objective is to protect the surface of a work platform from clay streaks and marks.

Another objective is to provide clay-related indicia directly on the wedging mat to help instruct a student in molding a ceramic material.

Another objective is to provide a clay mat for K-12 grades and any user that enjoys working with clay.

Yet another objective is to provide an inexpensive to manufacture clay mat.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary instructive clay mat assembly, showing clay-related indicia, in accordance with an embodiment of the present invention;

FIG. 2 illustrates a perspective view of a flexible panel, in accordance with an embodiment of the present invention;

FIG. 3 illustrates a perspective view of an exemplary instructive clay mat assembly, showing clay-related indicia and a QR code, in accordance with an embodiment of the present invention;

FIG. 4 illustrates a perspective view of a student carrying a rolled up panel and a carrying case to a work platform, in accordance with an embodiment of the present invention;

FIG. 5 illustrates a perspective view of a student laying the panel on the work platform to begin molding clay, in accordance with an embodiment of the present invention;

FIG. 6 illustrates a perspective view of an exemplary carrying case with clay molding tools, in accordance with an embodiment of the present invention; and

FIG. 7 illustrates a flow chart of an exemplary method of molding clay with an instructive clay mat assembly, in accordance with an embodiment of the present invention.

Like reference numerals refer to like parts throughout the various views of the drawings.

### DETAILED DESCRIPTION OF THE INVENTION

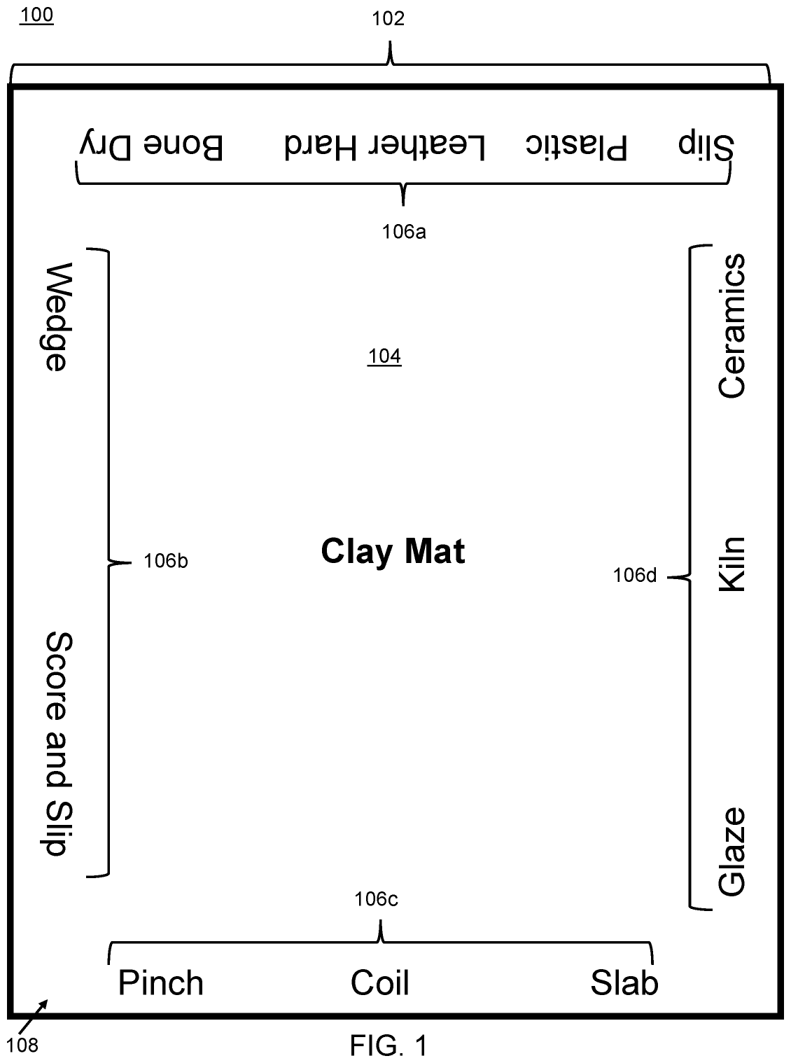

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An instructive clay mat assembly 100 and method 700 of use is referenced in FIGS. 1-7. The instructive clay mat assembly 100, hereafter “assembly 100” provides a portable wedging mat for molding a ceramic material 500, such as clay. The portable wedging mat is also configured to prominently display clay-related indica designed to create a narrative and instructive template for a student, with the indicia being arranged in a chronological order for providing instruction to a student in an art, or clay molding classroom environment. In some embodiments, the clay-related indicia 106a-d that provides instructions, techniques, and general information to assist the students while molding the ceramic material 500.

As referenced in FIG. 1, the assembly 100, comprises a flexible panel 102. In one possible embodiment, the panel 102 has dimensions of about 12″×22″. Thus, the panel 102 may be dimensioned as a generally square or rectangular shape. In another embodiment, the panel 102 comprises a washable, vinyl material. In yet another embodiment, the panel 102 comprises a canvas material.

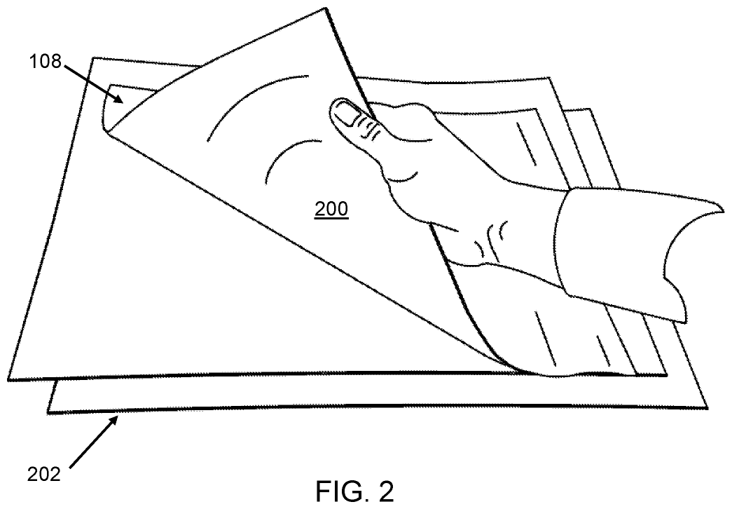

In some embodiments, the panel 102 defines a mount face 200 and an opposing clay face 104. The mount face 200 is configured to mounting on a work platform 202, such as a desk (See FIG. 2). In one non-limiting embodiment, the mount face 200 of the panel 102 is a nonporous material. In another possible embodiment, the mount face 200 of the panel 102 is a non-slip material. In operation, the mount face 200 mounts on a work platform 202 in an adjacent, parallel relationship. The clay face 104 is configured to enable a user to mold, or otherwise manipulate, a ceramic material 500 thereon. The clay face 104 also defines a perimeter region 108 and a central region. The perimeter region 108 can be anywhere from a few millimeters to a few inches wide.

In other embodiments, the panel 102 is a flexible, washable vinyl panel 102 sized to substantially cover a desk. However, in other embodiments, canvas could be another possible material option for the panel 102. The panel 102 is lightweight, so the user can carry between classes, wash it easily, and even write across the surface. The mount face 200 rests on a desk of an art student. The clay face 104 orients towards the user. The surface of the mount face 200 could be nonporous to prevent clay from streaking on the surface. The clay face 104 could also have depicted on it, indicia (numbers, letters, symbols) arranged to develop vocabulary, or provide images and text to explain how to wedge a block of clay. There could also be text that matches the text of a school book, or that is an instruction of a school.

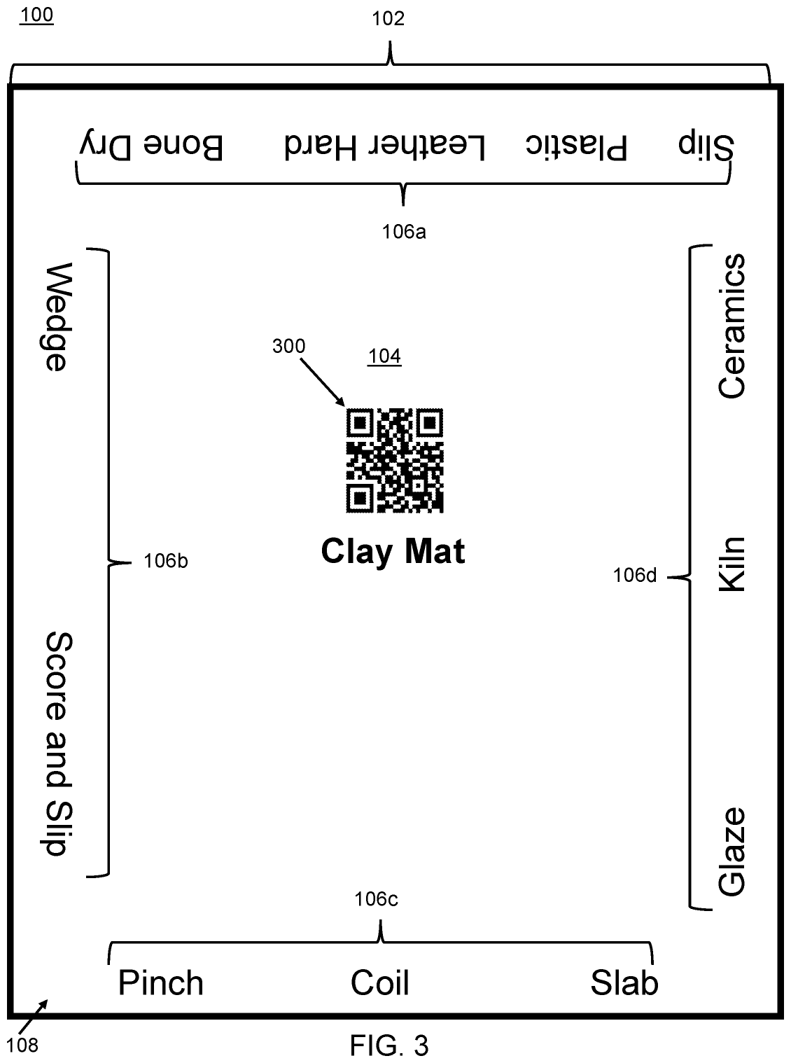

In alternative embodiments, a Quick Response (QR) code 300 displays on the clay face 104 (See FIG. 3). The QR code 300 is a two-dimensional version of the barcode, typically made up of black and white pixel patterns. In operation, the user could scan the QR code 300 with a communication device, such as a smart phone. The communication device may then connect to a clay-related video, text, file, or other instructive media related to clay and molding thereof. In this manner, the QR code 300 that links to at least one of the following clay-related digital entities: media, such as a video, text, image, or website.

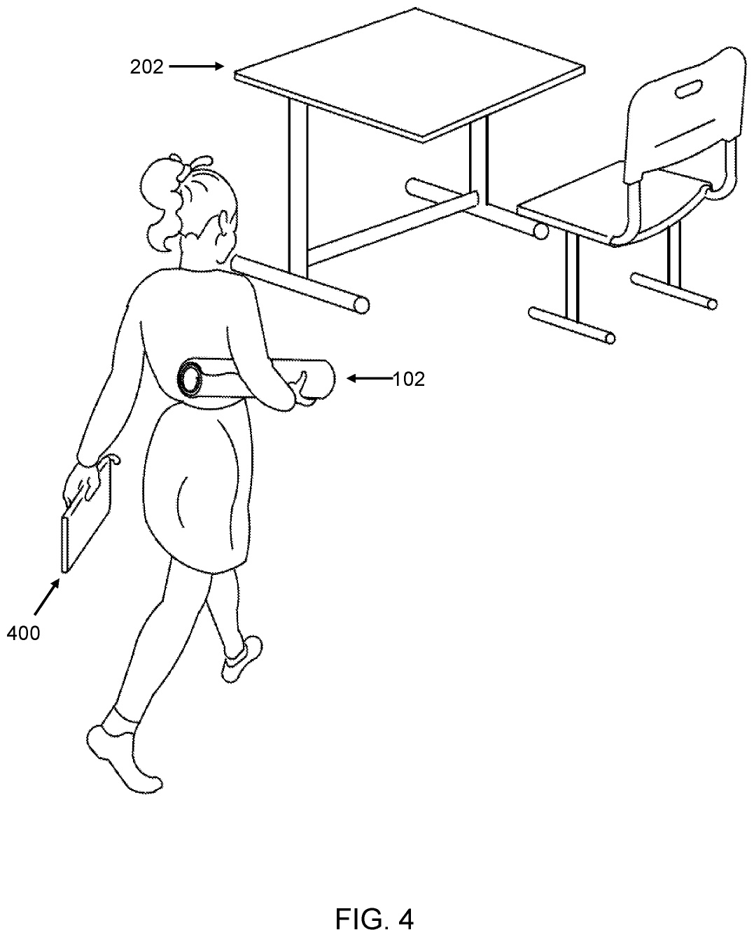

Turning now to FIG. 4, the assembly 100 provides a plurality of clay-related indicia 106a-d that prominently display along the perimeter region 108 of the clay face 104 to further enhance learning and creativity while molding the ceramic material 500. In some embodiments, the clay-related indicia 106a-d can include a text, a number, or an image. In another embodiment, the plurality of clay-related indicia 106a-d comprises at least twelve indicia. The clay-related indicia 106a-d correspond to at least one of the following: the type of the ceramic material 500, a technique for molding the ceramic material 500, a state of the ceramic material 500 while being molded, and a state of the ceramic material 500 after molding. In this manner, the clay-related indicia 106a-d help instruct in molding the ceramic material 500.

In keeping with the instructive and narrative purpose of the indicia, the clay-related indicia 106a-d include at least one of the following indicia: ceramics, wedge, slip, plastic, pinch, slab, coil, score and slip, leather hard, bone dry, fire, kiln, and glaze. The order of the terms is significant, since the student is reading the clay-related indicia 106a-d while molding; and thereby receiving instruction directly from the panel 102. One exemplary order and structure of clay-related indicia 106a-d may be as follows:

### Initial States of Clay

### 1. Slip

### 2. Plastic

### 3. Leather Hard

### 4. Bone Dry

### Clay Hand Building Techniques

### 5. Wedge

### 6. Score

### 7. Slip

### States Of Clay

### 8. Pinch

### 9. Coil

### 10. Slab

### Finished States of Clay

### 10. Glaze

### 11. Kiln

### 13. Ceramics

Alternative clay techniques may include, without limitation:

### Hand Building Techniques

slab
pinch
coil

### States of Clay

slip
plastic
leather hard
bone dry

### Finished States of Clay

glaze—ceramics
glaze firing

Thus, beginning with a portion of wedging clay, the student starts with an essential part of working with clay. It is the first step that prepares the clay so that it can be successfully molded, primarily because the air from within is removed. Once the wedging clay is placed on the clay face 104 of the panel 102, the student can refer to the clay-related indicia 106a-d at the perimeter region 108 of the panel 102 to mold the clay accordingly.

Below are clay-related indicia 106a for describing the state of the clay:

Slip—clay is most wet and pliable, easy to shape
Plastic—clay is easy to sculpt and model
Leather Hard—water has evaporated and now clay, like a leather shoe, is harder to work with but can carve into it
Bone Dry—clay that is dry and ready to be fired in the kiln

Below are clay-related indicia 106b for attaching the clay:

Slip—slip is a watery slurry of clay and water that can be used to attach two pieces of clay
Score and Slip/Wet and Attach—attaching two pieces of clay by scoring/roughing up adjoining edges using slip to stick together

Below are clay-related indicia 106c for clay hand building techniques:

Pinch—insert thumb into a ball of clay and continually pinch the clay between the thumb and fingers while rotating to thin out and raise the height of the vessel.
Slab—involves rolling out clay to an even thickness—usually 1 cm, then cutting out shapes, bending, manipulating and joining together to form a finished object.
Coil—roll out a coil on the wedging mat using the length of your hands—should look like a snake and be thinner than a pencil. One of the oldest hand building techniques used to make bowls.

Below are clay-related indicia 106d for the final steps in finishing the clay mold:

Ceramic Glaze—an impervious layer or coating of a vitreous substance which has been fused to a ceramic body through firing. Glaze can serve to color, decorate or waterproof an item.
Kiln—When work is bone dry—it is bisque fired in a kiln. There is electric, gas and wood type kilns. Electric kilns are most common. Those skilled in the art will recognize that a kiln is a thermally insulated chamber, or an oven that produces, such as hardening, drying, or chemical changes. Kilns are effective for transforming clay into pottery, tiles and bricks. The kiln reaches temperatures at 1830° Fahrenheit, while transforming the object into a porous state to allow the potter to glaze with ceramic glazes.
Ceramics—the finished product, often functional or decorative

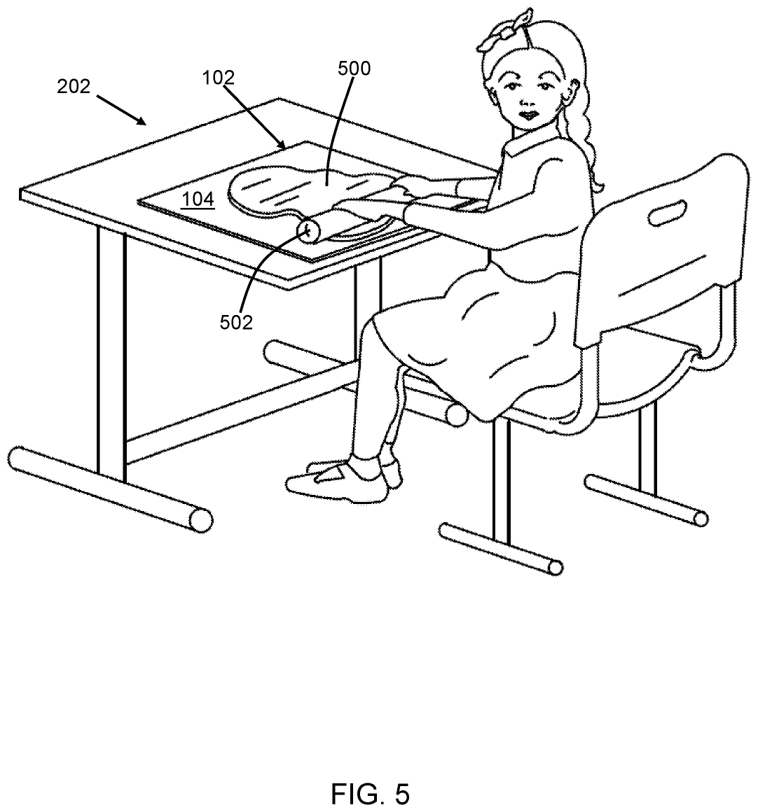

In operation, a user simply rolls up the panel 102 and carries to the work platform 202, such as a desk (See FIG. 4). This can be helpful in a classroom setting where multiple panel 102s are arranged, and accessible to the students upon entering the class. Also illustrated is a student carrying a portable carrying case 400 containing tools for manipulating the ceramic material 500/clay. Both the panel 102 and the carrying case 400 are lightweight and easy to operate. As FIG. 5 illustrates, the student has laid the panel 102 on the work platform 202, and is working on a portion of ceramic material 500. The student has also pulled a rolling pin 502 from the carrying case 400 to flatten the ceramic material 500 to a desired shape and dimension. After completing the project, the student can simply carry the panel 102 and carrying case 400 back to storage for the next students to use.

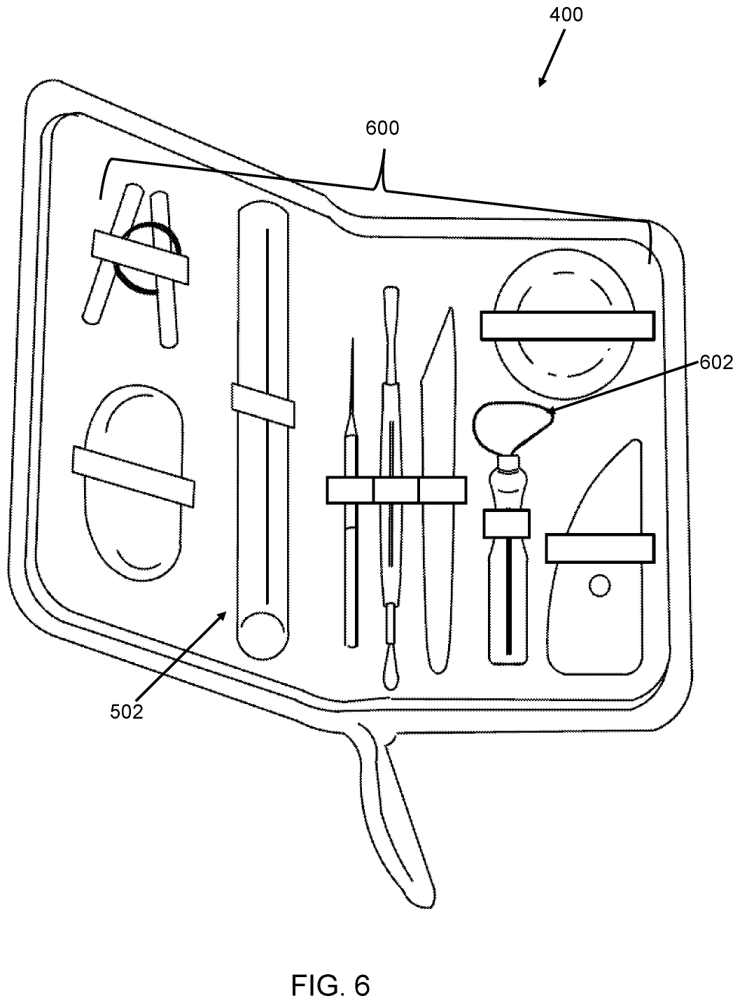

Turning now to FIG. 6, the assembly 100 provides a portable carrying case 400 that is used in conjunction with the panel 102. For example, the student can carry both the panel 102 and the carrying case 400 simultaneously to the work platform 202 to perform the clay molding operation. The carrying case 400 contains a plurality of clay molding tools 600. In some embodiments, the clay molding tools 600 may include, without limitation, a rolling pin, a sponge, a loop tool, a wire clay cutter, a pro needle, a boxwood tool, a potter's rib, a ribbon tool, and a metal scraper. In alternative embodiments, the wire clay cutter 602 extends across the mount face 200. The wire clay cutter may include a length of wire extending across the mount face 200, which can be pulled out for cutting clay. In alternative embodiments, handles, sticky substance, clay sculpturing tools, pens, or crayons could attach to the panel 102.

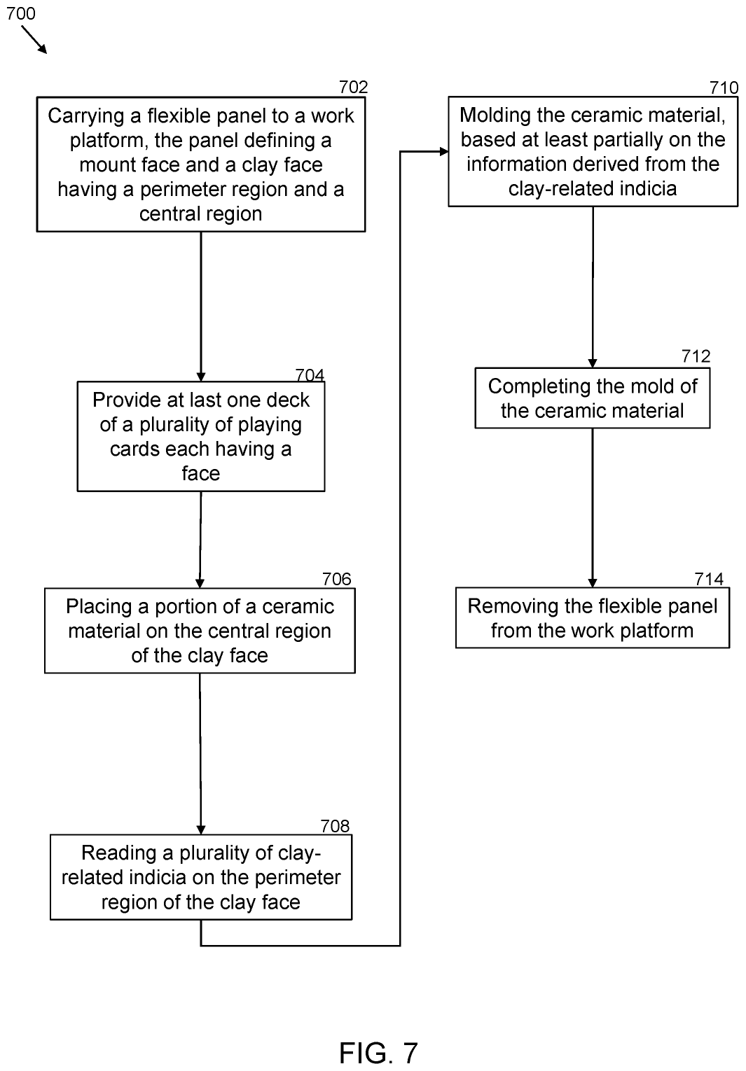

FIG. 7 illustrates a flowchart of an exemplary method 700 of molding clay with an instructive clay mat assembly. The method 700 may include an initial Step 702 of carrying a flexible panel to a work platform, the panel defining a mount face and a clay face having a perimeter region and a central region. The method 700 may further comprise a Step 704 of placing the mount face of the panel on the work platform. A Step 706 includes placing a portion of a ceramic material on the central region of the clay face.

In some embodiments, a Step 708 comprises reading a plurality of clay-related indicia on the perimeter region of the clay face. A Step 710 includes molding the ceramic material, based at least partially on the information derived from the clay-related indicia. In some embodiments, a Step 712 may include completing the mold of the ceramic material. A final Step 714 comprises removing the flexible panel from the work platform. At the end of molding clay, the user can wipe down the panel with water, lightly dry with paper towels and roll the mat up to be used again.

In conclusion, an instructive clay mat assembly 100 provides a lightweight, portable panel built for facilitated carrying and temporary use on a work platform. Further, the wedging mat assembly provides a plurality of clay-related indicia that provides instructions, techniques, and general information and instructions to assist students in molding clay in a classroom environment. The clay-related indicia include at least one of the following indicia: ceramics, wedge, slip, plastic, pinch, slab, coil, score and slip, leather hard, bone dry, fire, kiln, and glaze. The clay-related indicia are strategically disposed near the perimeter of the mat, so as not to be obstructed by the clay. Further, the clay-related indicia are arranged to create a clay molding narrative that helps the student during molding. The instructive nature of the indicia can include: clay types, clay building techniques, and states of during molding clay, and finished states of clay.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An instructive clay mat assembly, the assembly comprising:
a flexible panel defining a mount face and a clay face, the mount face being operable to enable mounting on a work platform, the clay face being operable to enable molding a ceramic material, the clay face having a perimeter region and a central region; and
a plurality of clay-related indicia disposed along the perimeter region of the clay face, the clay-related indicia corresponding to at least one of the following: the type of the ceramic material, a technique for molding the ceramic material, a state of the ceramic material while being molded, and a state of the ceramic material after molding,
whereby the clay-related indicia help instruct in molding the ceramic material.

2. The assembly of claim 1, wherein the panel has dimensions of about 12 inches×22 inches.

3. The assembly of claim 1, wherein the panel comprises a washable, vinyl material.

4. The assembly of claim 1, wherein the panel comprises a canvas material.

5. The assembly of claim 1, wherein the panel has a square shape or a rectangular shape.

6. The assembly of claim 1, wherein the panel displays a Quick Response code, the Quick Response code configured to digitally link to a clay-related media.

7. The assembly of claim 1, wherein the mount face of the panel is a nonporous material.

8. The assembly of claim 1, wherein the mount face of the panel is a non-slip material.

9. The assembly of claim 1, wherein the mount face mounts on a work platform in an adjacent, parallel relationship.

10. The assembly of claim 1, wherein the clay-related indicia include at least one of the following: a text, a number, and an image.

11. The assembly of claim 1, wherein the plurality of clay-related indicia comprises at least twelve indicia.

12. The assembly of claim 1, wherein the clay-related indicia include at least one of the following indicia: ceramics, wedge, slip, plastic, pinch, slab, coil, score and slip, leather hard, bone dry, fire, kiln, and glaze.

13. The assembly of claim 1, wherein the ceramic material comprises clay.

14. The assembly of claim 1, wherein the work platform comprises a desk.

15. The assembly of claim 1, further comprising a carrying case containing a plurality of clay molding tools.

16. The assembly of claim 15, wherein the clay molding tools include at least one of the following: a rolling pin, a sponge, a loop tool, a wire clay cutter, a pro needle, a boxwood tool, a potter's rib, a ribbon tool, and a metal scraper.

17. The assembly of claim 16, wherein the wire clay cutter extends across the mount face.

18. The assembly of claim 15, wherein the carrying case is portable.

19. An instructive clay mat assembly, the assembly consisting of:
a flexible panel defining a mount face and a clay face, the mount face being operable to enable mounting on a work platform, the clay face being operable to enable molding a ceramic material, the clay face having a perimeter region and a central region;
a plurality of clay-related indicia disposed along the perimeter region of the clay face, the clay-related indicia corresponding to at least one of the following: the type of the ceramic material, a technique for molding the ceramic material, a state of the ceramic material while being molded, and a state of the ceramic material after molding, the clay-related indicia including the following indicia: ceramics, wedge, slip, plastic, pinch, slab, coil, score and slip, leather hard, bone dry, fire, kiln, and glaze,
whereby the clay-related indicia help instruct in molding the ceramic material; and
a carrying case containing a plurality of clay molding tools.

20. A method of molding clay with an instructive clay mat assembly, the method comprising:
carrying a flexible panel to a work platform, the panel defining a mount face and a clay face having a perimeter region and a central region;
placing the mount face of the panel on the work platform;
placing a portion of a ceramic material on the central region of the clay face;
reading a plurality of clay-related indicia on the perimeter region of the clay face;
molding the ceramic material, based at least partially on the information derived from the clay-related indicia;
completing the mold of the ceramic material; and
removing the flexible panel from the work platform.
